(19) United States
(12) Patent Application Publication
(10) Pub. No.: US 2026/0216699 A1
(43) Pub. Date: Jul. 30, 2026

(54) CHROMATOGRAPHIC COMPOSITION AND METHODS OF PRODUCING THE CHROMATOGRAPHIC COMPOSITION

(71) Applicant: Advanced Materials Technology, Inc., Wilmington, DE (US)

(72) Inventors: Barry Edward Boyes, Wilmington, DE (US); Marc B. Goldfinger, West Chester, PA (US)

(21) Appl. No.: 19/146,311

(22) PCT Filed: Jan. 30, 2024
(86) PCT No.: PCT/US2024/013490

§ 371 Date: Jul. 8, 2025

Related U.S. Application Data
(60) Provisional application No. 63/444,663, filed on Feb. 10, 2023.

(51) Int. Cl. B01J 20/32; B01J 20/288; B01J 20/289

(52) U.S. Cl. CPC B01J 20/3227; B01J 20/288; B01J 20/289; B01J 20/3204

(57) ABSTRACT

A chromatographic composition includes a solid phase substrate and a first ligand covalently bonded to the solid phase substrate. The first ligand covalently bonded to the solid phase substrate is represented by Formula (I): Formula (I). In Formula (I), R₁ is independently selected from H or a straight or branched, substituted or unsubstituted, C1 to C18 alkyl group; R₂ is independently selected from H or a straight or branched, substituted or unsubstituted, C1 to C18 alkyl group; n is 2 to 8; m is 0 to 4; X is oxygen or nitrogen; and Y is a substituted or unsubstituted cyclic ring(s) structure including at least one nitrogen atom.

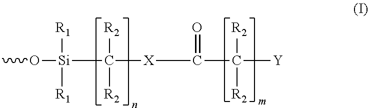

### CROSS-REFERENCE TO RELATED APPLICATION

The present application claims priority to and all the benefits of U.S. Provisional Patent Application No. 63/444,663 filed on Feb. 10, 2023, which is hereby expressly incorporated herein by reference in its entirety.

### FIELD OF THE DISCLOSURE

The present disclosure generally relates to a chromatographic composition for use in chromatographic separations.

### BACKGROUND

High Performance Liquid Chromatography (HPLC) is a process of separating components in a liquid mixture. Various forms of HPLC exist, such as ion exchange, reversed-phase (RP), hydrophilic interaction liquid chromatography (HILIC), and mixed-mode RP and HILIC liquid chromatography, with ion exchange characteristics. Each of these variants include a mobile phase and a stationary phase that cooperate to accomplish the separation. Despite the general ability of liquid chromatography to retain and separate polar analytes, conventional stationary phases are not optimized to separate certain mixtures. For example, conventional separations of basic compounds have been noted to exhibit poor peak profiles in a concentration-dependent manner, particularly when analyzed using favored RP HPLC analysis conditions. This typical poor peak profile may limit resolution of closely eluting compounds, particularly when impurities are present in small quantities. Thus, there remains an opportunity to develop an improved chromatographic composition.

### SUMMARY OF THE DISCLOSURE

In one aspect of the present disclosure, a chromatographic composition is provided. The chromatographic composition includes a solid phase substrate and a first ligand covalently bonded to the solid phase substrate. The first ligand covalently bonded to the solid phase substrate is represented by Formula I:

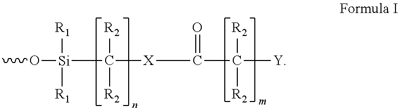

In Formula I, R¹ is independently selected from H or a straight or branched, substituted or unsubstituted, C1 to C18 alkyl group; R² is independently selected from H or a straight or branched, substituted or unsubstituted, C1 to C18 alkyl group; n is 2 to 8; m is 0 to 4; X is oxygen or nitrogen; and Y is a substituted or unsubstituted cyclic ring(s) structure including at least one nitrogen atom.

In another aspect, the present disclosure provides a method of producing the chromatographic composition. The method includes providing a first ligand portion represented by Formula IV:

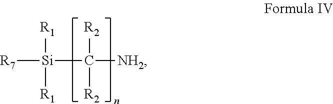

wherein R₁ is independently selected from H or a straight or branched, substituted or unsubstituted, C1 to C18 alkyl group; R₂ is independently selected from H or a straight or branched, substituted or unsubstituted, C1 to C18 alkyl group; R₇ is a leaving group, and n is 2 to 8. The method further includes reacting the solid phase substrate and the first ligand portion to covalently couple the solid phase substrate and the first ligand portion and form a first intermediate.

The method further includes providing an amide-forming reaction compound represented by Formula V:

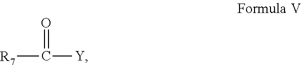

wherein R7 is a leaving group and Y is the substituted or unsubstituted cyclic ring(s) structure including at least one nitrogen atom. The method further includes reacting the amide-forming reaction compound and the first intermediate to produce the first ligand covalently coupled to the solid phase substrate and thereby produce the chromatographic composition.

### BRIEF DESCRIPTION OF THE DRAWINGS

Advantages of the present invention will be readily appreciated, as the same becomes better understood by reference to the following detailed description, when considered in connection with the accompanying drawings.

FIG. 1 provides chromatograms showing the separation of two strongly basic compounds, nortriptyline and amitriptyline, using one HPLC column loaded with a material produced with a composition of the first ligand of this disclosure derived from pyridinyl-amidopropyl (diisopropyl) silane (PyrAmPrDiP) present on a silica substrate, with the substrate further including a second ligand derived from a C18 hydrophobic ligand and an end capped product derived from a trimethyl silane end capping reagent, compared to a control C18 HPLC column.

FIG. 2 is a chromatogram showing the separation of various charged and uncharged compounds using HPLC columns loaded with materials produced with varying amounts of a first ligand derived from pyridinyl-amidopropyl (diisopropyl) silane (PyrAmPrDiP) present on a silica substrate, with the substrate further including a second ligand derived from a C18 hydrophobic ligand and an end capped product derived from a trimethyl silane end capping reagent.

FIG. 3 is a chromatogram showing an example of a modified (PyrAmPrDiP) surface that was reacted with a phenylhexyl silane second ligand as a hydrophobic modifier (CatPhex), then subjected to characterization by HPLC separations of a mixture of small organic molecules overlaid with a control without the (PyrAmPrDiP) modification (Phex).

### DETAILED DESCRIPTION OF THE DISCLOSURE

The present disclosure provides a chromatographic composition. The chromatographic composition is useful in chemical separations, particularly HPLC separations that include a stationary phase and a mobile phase.

The chromatographic composition includes a solid phase substrate and a first ligand covalently bonded to the solid phase substrate. The first ligand is represented by Formula I:

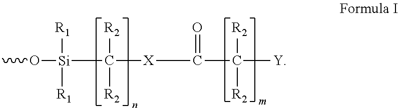

wherein: R₁ is independently selected from H or a straight or branched, substituted or unsubstituted, C1 to C18 alkyl group. R₂ is independently selected from H or a straight or branched, substituted or unsubstituted, C1 to C18 alkyl group. The subscript n is 2 to 8 and the subscript m is 0 to 4. X is oxygen or nitrogen. Y is a substituted or unsubstituted cyclic ring(s) structure including at least one nitrogen atom.

Referring first to the solid phase substrate, although not required, the solid phase substrate is typically silica. The silica used for the chromatographic composition is not limited to any particular grade. Both nonporous spherical silica and porous silica, including superficially porous silica, may be used. The silica particles typically have an average diameter particle size of from 0.5-100 μm, from 1-50 μm, from 1.5-10 μm, or from 1.7-5 μm. The porous silica may have an average pore diameter of greater than or equal to about 80 Å, greater than or equal to about 250 Å, greater than or equal to about 300 Å, greater than or equal to about 450 Å, from 200 to 1,500 Å, from 250 to 900 Å, or from 300 to 850 Å. Alternatively, although pore diameters below 70 Å are typically avoided, it is contemplated that the average pore diameter may be from about 1 to about 50 Å, from about 5 to about 40 Å, or from about 10 to about 30 Å. The surface of the silica particles typically includes silica hydroxyl groups, so-called silanols, useful for covalent coupling of various reagents to the silica surface. Most commonly, specific organosilane reagents or ligands are employed for these silica surface modifications, to form a covalent attached bonded phase. Suitable grades of silica are available under the tradename Halo® Silica from Advanced Materials Technologies having a principal place of business in Wilmington, DE. Alternatively, many silica materials are widely available as commercial materials for a variety of useful applications.

Alternative solid phase substrates include hybrid inorganic/organic material. Within the context of this disclosure, the term “hybrid inorganic/organic material” includes inorganic-based structures wherein an organic functionality may be integral to both the internal core and particle surface, or to just the particle surface. The inorganic portion of the hybrid material may be, e.g., alumina, silica, titanium, cerium, or zirconium or oxides thereof, or ceramic material. Further alternative substrates include completely organic substrates that include hydroxyl groups at the surface of the organic substrate. For the purposes of this disclosure, the solid phase substrate is not formed from carbohydrates.

Referring back to the first ligand, as described above, R₁ is independently selected from H or a straight or branched, substituted or unsubstituted, C1 to C18 alkyl group. In other words, each R₁ present in Formula I may be different. Although not required, R₁ is more commonly a straight or branched, substituted or unsubstituted, C1 to C6 alkyl group. In certain embodiments, both R₁ groups are straight or branched, substituted or unsubstituted, C1 to C6 alkyl groups. For example, in certain implementations, each R₁ may be a branched alkyl group with a total of 3 carbon atoms.

Referring still to the first ligand, R₂ may be further defined as H or a straight or branched, substituted or unsubstituted, C1 to C6 alkyl group. In certain embodiments, when R₂ is an alkyl group, R₂ is not substituted. In certain embodiments, each R₂ is hydrogen. When each R₂ is hydrogen, n is typically from 3 to 6. Referring now to the variable X in Formula I, X represents either oxygen or nitrogen. Typically, X is nitrogen. Although not required, the subscript m is typically zero when each R₂ is hydrogen, n is from 3 to 6, and X is nitrogen.

The end group Y of the first ligand represents a substituted or unsubstituted cyclic ring(s) structure including at least one nitrogen atom. It is to be appreciated that Y may be a single cyclic ring or a multi-ring structure, provided that at least one nitrogen atom is included in at least one of the rings. There is no particular limit to the size of the cyclic ring(s) in the cyclic ring(s) structures. In certain embodiments, each cyclic ring within Y, may be a 3 to 8 member cyclic ring with at least one of the rings including nitrogen as part of the cyclic ring. For example, when Y is a singular ring structure, Y may be derived from pyridine or pyrrole. When the cyclic ring structure is derived from pyridine, the nitrogen atom contained within the cyclic ring may be present at either the ortho, meta, or para position. Typically, the nitrogen atom contained within the cyclic ring is present at either the meta or para position. When Y is a multi-ring structure, Y may be derived from purine or isoquinoline, or other heterocyclic multiring structures.

In certain embodiments, R₁ is a straight or branched, unsubstituted, C1 to C18 alkyl group, R₂ is hydrogen, X is nitrogen, m is zero, and Y is derived from pyridine or pyrrole. In one embodiment, the first ligand covalently bonded to the solid phase substrate is represented by Formula Ia:

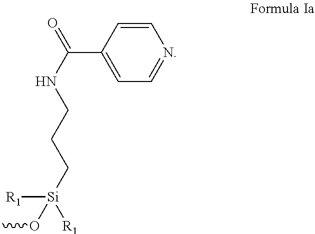

In certain embodiments, the terminal group Y is capable of bearing a positive ionic charge in neutral or acidic aqueous or aqueous organic solvent conditions. Persons of ordinary skill in the art will understand that the phrase “capable of” within the context of bearing a positive ionic charge means that the terminal group Y is positive when exposed to the aqueous or aqueous organic solvent conditions. Persons of ordinary skill in the art will also understand that when the terminal group Y is not exposed to these conditions, the terminal group may be neutral.

Referring back to the chromatographic composition as a whole, in addition to having the first ligand covalently bonded to the solid phase substrate, the chromatographic composition may include a second ligand covalently bonded to the solid phase substrate. Without being bound to any particular purpose, the second ligand is typically selected to establish a hydrophobic environment to promote hydrophobic interactions with the analyte to favor partitioning into the stationary phase from the mobile environment. The second ligand, and the concentration thereof, may be selected and tailored based on the particular analytes of interest. In certain embodiments, the second ligand covalently bonded to the solid phase substrate is represented by Formula II:

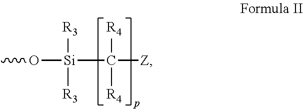

wherein: R₃ is independently selected from H or a straight or branched, substituted or unsubstituted, C1 to C18 alkyl group; R₄ is independently selected from H or a straight or branched C1 to C17 alkyl group; p is 2 to 29; Z is a methyl or a phenyl group, with the phenyl group being optionally substituted with at least one halogen. In one implementation of Formula II, R₃ is a straight or branched, C1 to C6 alkyl group, R₄ is hydrogen and p is 15 to 17 and Z is methyl. When R₃ is methyl, R₄ is hydrogen, p is 17, and Z is methyl, the second ligand may be referred to as octadecyl dimethyl silane. In another implementation, R₃ is a straight or branched, C1 to C6 alkyl group, R₄ is hydrogen, p is 4 to 8 and Z is phenyl. When R₃ is methyl, R₄ is hydrogen, p is 6, and Z is phenyl, the second ligand may be referred to as phenylhexyl dimethyl silane. In another implementation, R₃ is a straight or branched, C1 to C6 alkyl group, R₄ is hydrogen, p is 2 to 12 and Z is a phenyl group including five fluorine atoms. In another implementation, when R₃ is methyl, R₄ is hydrogen, p is 6, and Z is a phenyl group including five fluorine atoms, the second ligand may be referred to as pentafluorophenylhexyl dimethyl silane. It is to also be appreciated that halogen atoms other than fluorine, such as chlorine, bromine, and/or iodine, may be used.

Referring still to the chromatographic composition as a whole, in addition to having the first ligand covalently bonded to the solid phase substrate and optionally the second ligand bonded to the solid phase substrate, the chromatographic composition may include an end capped product covalently bonded to the solid phase substrate. Without being bound to any particular theory or particular purpose, the end capped product is typically used to consume residual silanol groups, which may have an anionic character. The anionic character of the residual silanol groups is generally undesirable due to its tendency to exhibit undesirable interaction with polar analytes in RP HPLC. When included, the end capped product covalently bonded to the solid phase substrate is represented by Formula III:

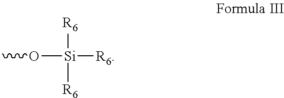

R₆ is independently selected from a hydrophobic structure including at least one carbon, which may be a substituted or unsubstituted aliphatic, cyclic, acyclic, aromatic hydrocarbon, heterocyclic compound, or combination thereof, with optional substitution of chemical functional groups therein. Generally, the end capped product, including the optional substitution of chemical functional groups, is selected to be a small, stable, neutral compound, which does not ionize under typical chromatographic conditions, such as the aqueous or aqueous organic solvent conditions commonly associated with chromatographic environments. In one implementation, each R₆ in Formula III is a methyl group.

In certain embodiments, the chromatographic composition includes the first and second ligands covalently bonded to the solid phase substrate. The molar ratio of the first and second ligands covalently bonded to the solid phase substrate may range from 10 to 90 mol. % of the first ligand with the remainder being the second ligand (i.e., 90 to 10 mol. % of the second ligand). In other embodiments, the chromatographic composition includes the first ligand and the end capped product covalently bonded to the solid phase substrate. The molar ratio of the first ligand and the end capped product covalently bonded to the solid phase substrate may range from 10 to 90 mol. % of the first ligand and 90 to 10 mol. % of the end capped product. In still further embodiments, the chromatographic composition includes the first ligand, the second ligand, and the end capped product covalently bonded to the solid phase substrate. The molar ratio of the first ligand, second ligand, and end capped product covalently bonded to the solid phase substrate may range from 5 to 90 mol. % of the first ligand, 5 to 90 mol. % of the second ligand, and 1 to 80 mol. % of the end capped product. The exact molar ratio of the first ligand, second ligand, and/or end capped product may be selected and optimized to separate a specific class or type of compounds during chromatographic analysis. Generally, the solid phase substrate of the chromatographic composition is only modified with the first ligand, second ligand, and end capped product. In alternative embodiments, the total mole percent of the first ligand, second ligand, and end capped product represents at least 95% of the total moles of compounds covalently coupled to the solid phase substate via the silanol groups of the solid phase substate. It is understood that after such reactions, residual silanol groups may remain unreacted on or near the surface of the particle structure.

The present disclosure also provides a method of producing the chromatographic composition. The method includes providing the solid phase substrate and providing a first ligand portion. The first ligand portion is represented by Formula IV:

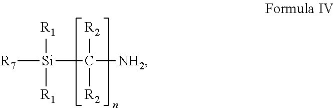

wherein R₇ is a leaving group. The leaving group may be an alkoxy such as a methoxy or ethoxy group, a dialkylamine such as dimethylamine, or a halide such as chlorine. In one implementation, the leaving group, R₇, is dimethylamine, such that Formula IV is further defined as Formula IVa:

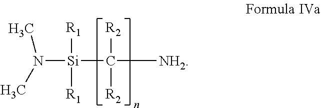

In another implementation, the leaving group, R₇, is ethoxy, such that Formula IV is further defined as Formula IVb:

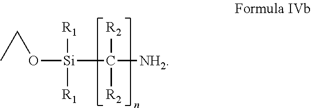

Alternative leaving groups are also contemplated.

The method further includes reacting the solid phase substrate and the first ligand portion to covalently couple the solid phase substrate and the first ligand portion and form a first intermediate. Once the reaction between the solid phase substrate and the first ligand portion is complete, the resulting reaction product produces the first ligand portion covalently coupled to the solid phase substrate. An illustrative reaction is provided below with the leaving group represented by ethoxy and the solid phase substrate including a silanol group.

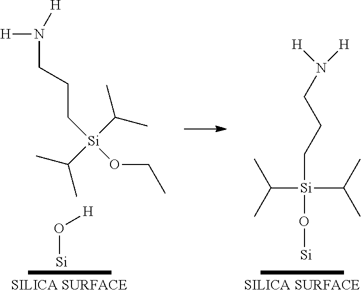

The method further includes providing an amide-forming reaction compound represented by Formula V:

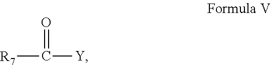

where R7 is the leaving group defined above and Y is the substituted or unsubstituted cyclic ring(s) structure including at least one nitrogen atom.

In one implementation, R₇ is a chlorine atom and Y is pyridine such that Formula V is further defined as Formula Va:

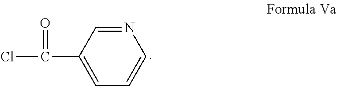

In another implementation, R₇ is a chlorine atom and Y is pyridine such that Formula V is further defined as Formula Vb:

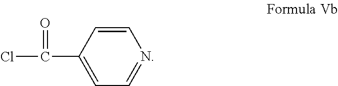

In one implementation, R₇ is a ethoxy and Y is pyridine such that Formula V is further defined as Formula Vc:

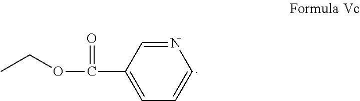

In another implementation, R₇ is ethoxy and Y is pyridine such that Formula V is further defined as Formula Vd:

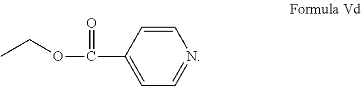

In certain implementations, the amide-forming reaction product is selected from isonicotinoyl chloride or ethyl isonicotinate.

The method further includes reacting the first intermediate and the amide-forming reaction compound. An illustration disclosing a representative reaction between the first intermediate and the amide-forming reaction compound is provided below, with the amide-forming reaction compound being represented by Formula Vb:

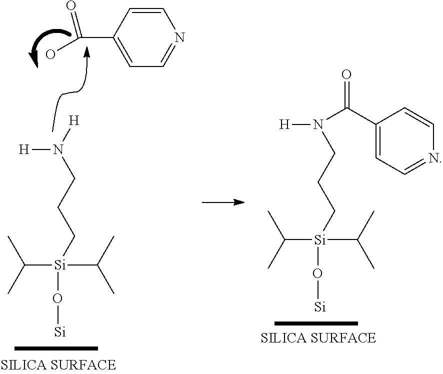

An illustration disclosing another representative reaction between the first intermediate and the amide-forming reaction compound is provided below, with the amide-forming reaction compound being represented by Formula Vd.

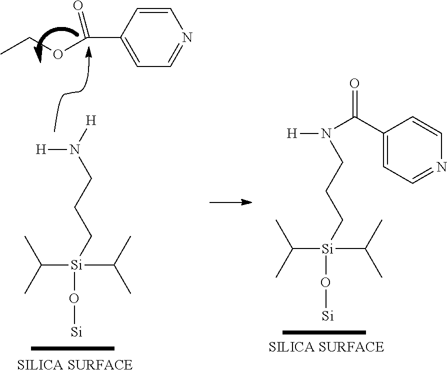

Once the reaction between the first ligand portion and the amide-forming reaction compound occurs, the resulting reaction product is the first ligand covalently coupled to the solid phase substrate as represented by Formula I.

The method may optionally further include reacting a second ligand portion and/or an end capping reagent with the solid phase substrate. The second ligand portion and the end capping reagent are represented by Formula VI and VII, respectively.

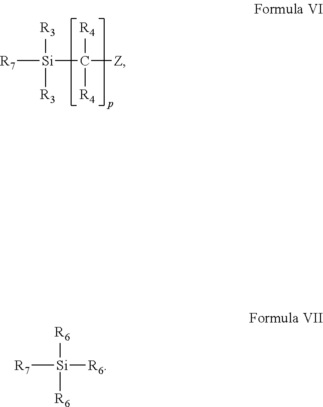

Within Formulas VI and VII, R₃, R₄, R₆, R₇, p, and Z are defined above.

Although described above as subsequent reaction steps, the present disclosure also contemplates reacting the first ligand portion with the solid phase substrate contemporaneously with the reaction between the second ligand portion and end capping reagent with the solid phase substrate. It is to be appreciated that after the end capping reagent has reacted with the solid phase substrate, the resulting reaction product is generally referred to as the end capped product. Typically, the reactions involving the second ligand and/or end capping reagent are carried out under anhydrous conditions with aprotic solvents with an optional base catalyst.

As another alternative to the method described above, the chromatographic composition may also be prepared by forming the first ligand in solution by first reacting the first ligand portion and the amide-forming reaction compound. The resulting off-particle reaction product may then be combined with the solid phase substrate to covalently couple the solid phase substrate to the off-particle reaction product and produce the first ligand covalently coupled to the solid phase substrate represented by Formula I. A representative two-step reaction scheme is provided below, which may informally be referred to as off-particle synthesis:

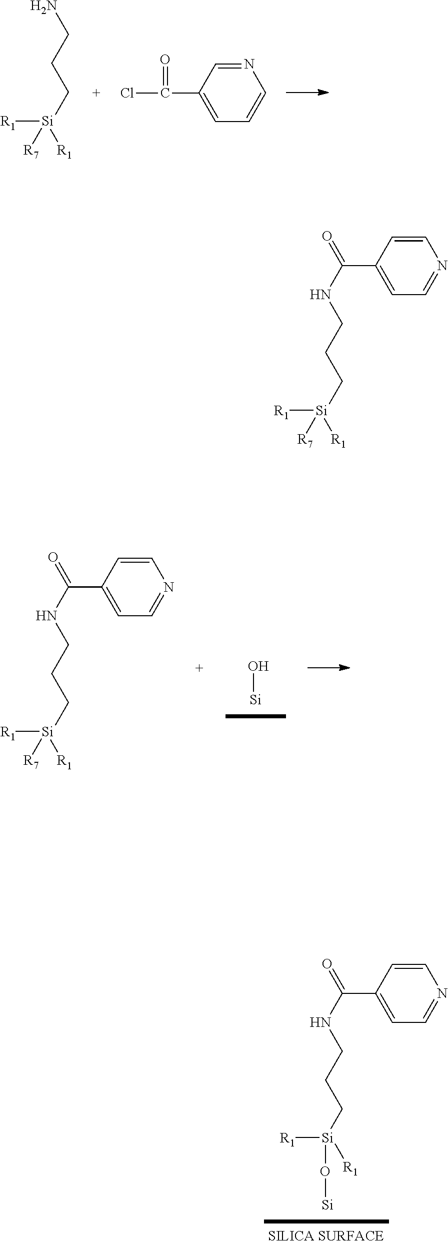

In certain embodiments, when the first ligand, second ligand, and end capped product are included, the exemplary chromatographic material may have the following structures:

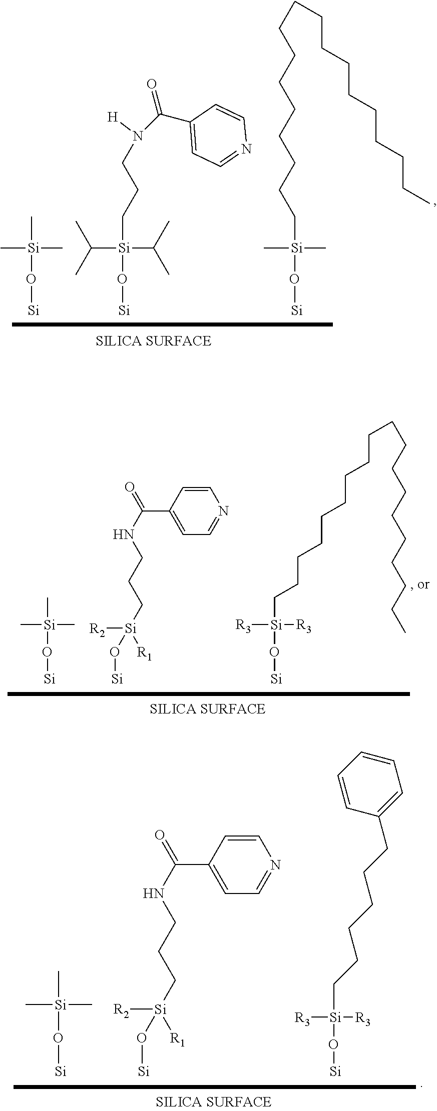

As described above, the chromatographic composition is useful for HPLC separations. Further uses include, but are not limited to, a thin layer plate, a filtration membrane, a microfluidic separation device, a sample cleanup device, a solid support, a solid phase extraction device, a microchip separation device, or a microtiter plate. The chromatographic composition may also be included in a kit, with the kit optionally including instructions for use of the chromatographic composition.

### EXAMPLES

Those skilled in the art will recognize that equivalents of the following instruments and suppliers exist and, as such, the instruments listed below are not to be construed as limiting.

The elemental analysis of silica particles (% C, % H, % N) were measured by combustion analysis (Robertson Microlit Laboratories, Ledgewood, NJ). These values were employed to establish ligand coverage measures based on known composition of compounds and Specific Surface Areas (m2/g). The specific surface areas (SSA), specific pore volumes (SPV) and the average pore diameters (APD) of these materials were measured using the multi-point N₂ sorption method (Micromeritics ASAP 2400; Micromeritics Instruments Inc., Norcross, Ga.). The SSA was calculated using the BET method, the SPV was the single point value determined for P/P₀>0.98 and the APD was calculated from the desorption portion of the isotherm using the BJH method. Particle sizes were measured using a Beckman Coulter Multisizer 3 analyzer (30 μm aperture, 70,000 counts; Miami, Fla.). The particle diameter (dp) was measured as the 50% cumulative diameter of the volume-based particle size distribution. The width of the distribution was measured as the 90% cumulative volume diameter divided by the 10% cumulative volume diameter (denoted 90/10 ratio). Generally, values of surface coverage are expressed as normalized to the elemental composition and SSA of samples, to yield molar surface coverage of the silica surface with ligand in μmol/m2. MS analysis and GC/MS analysis followed using standard methods.

### Preparation of Surface Charged Particles

In principle the modification of the silica surface with the first ligand can be obtained by activation of the surface with the aminopropyldiisopropyl (APD) silane, as a reactive intermediate, followed by reaction with a suitable reacting group, or by reaction of the surface with a completed silane, possessing a suitable surface silanol reactive silane leaving group. Below we show examples of completed silane structures, derived from previous reaction of APD to yield the completed pyridinyl-amidopropyl-diisopropylsilane, substituted with a suitable siloxane leaving group, such as an alkoxy or chlorosilane.

Reaction of Silane with Pyridinyl Group

Examples of the completed silane included reactions of the amino silane, 3-aminopropyl-diisopropyl-ethoxysilane (APD, Gelest Inc., Morrisville, PA), were prepared in dry solvents, to assess reactivity of the nucleophilic primary amine towards active intermediates of the pyridinyl structure (ortho-, meta- and para-substituted pyridinyl ring targets). In one example, a solution of ethyl-isonicotinate (EIN) was prepared in dry toluene, to which triazabicylcodecane as a catalyst was added for reaction with APD at 110° C. At various times samples were removed to assess the formation of the silyl-ligand, pyridinyl-amidopropyl-diisopropylethoxylsilane. Samples were diluted in ethylacetate prior to analysis by GC/MS, confirming the reaction product mass of 279.2 amu, which also exhibited an NMR spectrum consistent with the intended reaction product—¹H NMR (CDCl₃, 400 MHz): δ_{H} 0.69 (2H, m), 1.03 (14H, m), 1.18 (3H, t), 1.74 (2H, dt), 3.45 (2H, m), 3.74 (2H, q), 7.62 (2H, d), 8.73 (2H, d). A similar reaction was conducted employing the acid chloride derivative of isonicotinyl chloride (INC) in dry acetonitrile, resulting in the desired reaction product of pyridinyl-amidopropyl-diisopropylethoxylsilane, as confirmed by GC/MS analysis with a mass 279.2, and same retention time as the reaction product produced by the use of the ethyl ester EIN pyridyl donor reaction. Thus, either the ethyl ester or acid chloride reactions are confirmed to yield the formation of the ethoxysilyl reagent that can be employed for modification of silica surfaces through silanol groups on the surface.

The subject modifications of the particle surface can also be conducted by activation of the surface by various levels of the primary amine silane, APD, followed by formation of the completed subject modification by further reaction of the intermediate amino-propylsilane modified surface, APD silica particles.

### Preparation of APD Silica Particles

Commercially available 2.7 μm diameter fully hydroxylated superficially porous silica particles (25 g of Halo Silica, Advanced Materials Technologies, Wilmington, DE) were dispersed while under a blanket of nitrogen, refluxed in toluene (250 mL, Millipore/Sigma, St. Louis, NJ) using a Dean-Stark trap for 1 hour, to collect a small quantity of adsorbed water. To examine the effects of bonded ligand density, the quantities of catalyst and 3-aminopropyl-diisopropyl-ethoxysilane (APD, Gelest Inc., Morrisville, PA) are varied from 0.05 moles of APD to 1 moles of APD, relative to the quantities of silanols present on the surface of the silica particles (generally assumed to be present at 8 μmol/m2 of particle surface area). After brief cooling to about 65° C., a quantity of triethylamine (TEA, Sigma-Aldrich, St. Louis, MO) was added with stirring, followed by addition of the APD. The resulting mixture was heated to 78° C., to remove the bulk of ethanol, then brought to reflux overnight, with occasional collection of about 5 mL portions of solvent to aid removal of the ethanol evolved during bonding of the ethoxy-silane to the surface of the silica particles. After cooling, the resulting silica particles were collected by filtration on a sintered glass funnel, washed three times with 200 mL of toluene, once with acetonitrile, then methanol, before being collected by filtration onto Whatman filter paper. The dried particles were dispersed into 150 mL of 50% acetonitrile/water buffered with 0.5 M ammonium bicarbonate, with stirring for 30 minutes, before collection by filtration, washing 3 times each with portions of 50% acetonitrile/water, acetonitrile, and methanol (all solvents from Sigma-Millipore). The filter dried silica was further dried in a vacuum oven at 110° C. for at least 1 hour, prior to characterization by chromatographic analysis and/or elemental analysis.

### Reactions of APD Silica to Form Pyridyl-Amido-Silane Modified Surfaces

APD bonded silicas were prepared at various levels of modification, from 0.05 μmol/m² to 0.75 μmol/m². These APD silica particle intermediates were reacted under nitrogen in dry acetonitrile, using diisopropylethylamine (DIPEA), and various sources of pyridinyl donor groups, to form the amido connected structures. In general, the basic catalyst was present at 4-8 fold molar excess, relative to the quantity of amine groups present on the aminosilane bonded silica surfaces. In general, 2-6 fold molar excess of donor pyridinyl reagent was employed to fully react the free amine on the surface of the APD silica particles. For example, nicotinyl chloride hydrochloride or iso-nicotinylchloride hydrochloride, or either iso-nicotinyl acid anhydride, or nicotinyl acid anhydride at room temperature overnight. The solids are recovered by filtration, washing with 200 mL of acetonitrile three times, lightly dried, followed by dispersion into 50% acetonitrile/water/0.2% acetic acid, with heating to 40° C. for 30 minutes. The particles are collected by filtration and washing with tetrahydrofuran, acetonitrile and methanol. The pyridinyl-amidopropyl (diisopropyl) silane (PyrAmPrDiP) surface modified silica was dried as before under vacuum at 110° C. Elemental analysis of the resulting modified surfaces confirmed that the reactions yielded expected C, H, N levels for reacted APD modified silica surfaces.

Formation of Charged Surfaces with Hydrophobic Ligands for Reversed-Phase Separations

APD modified, or the amido-pyridinyl modified (PyrAmPrDiP) surfaces, were further reacted with various second ligands to produce hydrophobic mixed phases of surface charged and hydrophobic surface silica particles. For reference herein, two examples include the octadecylsilane (C18) and phenylhexyl (PH) modified surfaces. The surface reactions to produce PyrAmPrDiP as the surface charge modifier, with C18 and PH as the hydrophobic ligands to produce mixed phases are produced by similar means. A 20 g portion of dried PyrAmPrDiP modified silica, at specific targeted level of modification, is added to a round bottom flask of 250 mL, to which is added 140 mL of toluene, a magnetic stirring bar operated at 500-700 rpm, a reflux condenser, and a Stark Trap. The resulting mixture was heated to 110° C., water removed through the Stark Trap, then 21.2 g of octadecyldimethyl (dimethylamino) silane was added. The resulting mixture was maintained at reflux overnight, with a slow bleed of N₂ gas through the reflux condenser. After cooling, the resulting silica particles were collected by filtration on a sintered glass funnel, washed three times with 60 mL of dry toluene, twice with 60 mL of THF, then is brought to reflux in 50% THF/water for 1 hour. After collection of the particles, the material is dispersed in acetonitrile, brought to reflux, then collected by filtration, then washed with 60 mL acetonitrile, 60 mL of methanol, then the filter dried silica was further dried in a vacuum oven at 110° C. for at least 1 hour. To the dried silica is added 180 mL of toluene in the round bottom flask, which is brought to reflux, and water removed as described above, then allowed to cool, before addition of 6.85 g of the end-capping reagent, (N,N-dimethylamino) trimethylsilane (TMS). The resulting mixture was heated to reflux, and allowed to react overnight. The reaction was allowed to cool, then the particles collected by filtration, followed by washing with 3 portions of toluene, 3 portions of THE, dispersed in THF and refluxed, then collected, washed further twice with acetonitrile, refluxed in acetonitrile, collected, washed with 2 portions of acetonitrile, and dried under vacuum. By the same process, the phenylhexyl ligand modified surface is prepared by substitution of octadecyldimethyl (dimethylamino) silane by phenylhexyl dimethyl (dimethylamino) silane, at the same molar equivalent quantities.

### Chromatographic Characterization of Column Packing Materials

Analyses of the performance of various HPLC column packing materials were conducted by slurrying the particles in various solvents for high pressure loading the particles into stainless steel tubing blanks. The resulting packed bed particles were examined for HPLC separations using standard methods, with samples chosen to evaluate elution times and peak profiles for various acidic, basic and neutral organic molecules.

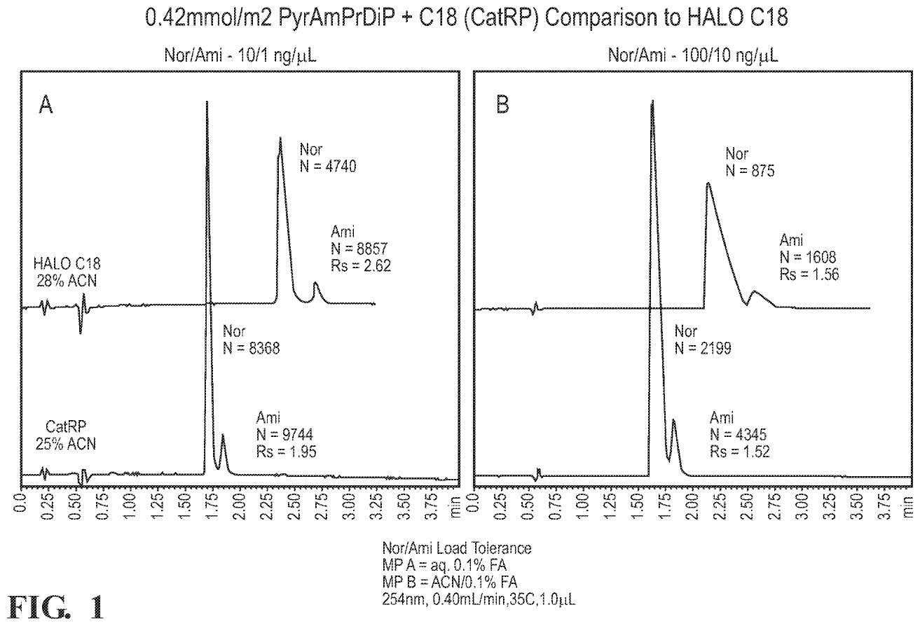

FIG. 1 presents the separation of two strongly basic compounds, nortriptyline and amitriptyline, compared on the HALO® C18 column, which is not charge surface modified to the mixed positively modified hydrophobic phase surface prepared material. The nortriptyline peak elutes earlier, despite a lower acetonitrile organic modifier concentration, than is seen on the HALO® C18, and has an improved peak shape (less asymmetrical and narrower), at low load of the compounds (10 ng/Ing), as shown in Panel A. As the quantity of material is increased (100 ng/10 ng), shown in Panel B, resolution of the compounds is affected to a greater extent on the HALO® C18, due to greater peak broadening and an increase in peak asymmetry. The positively charged surface material better tolerates an increase in sample load for basic compounds.

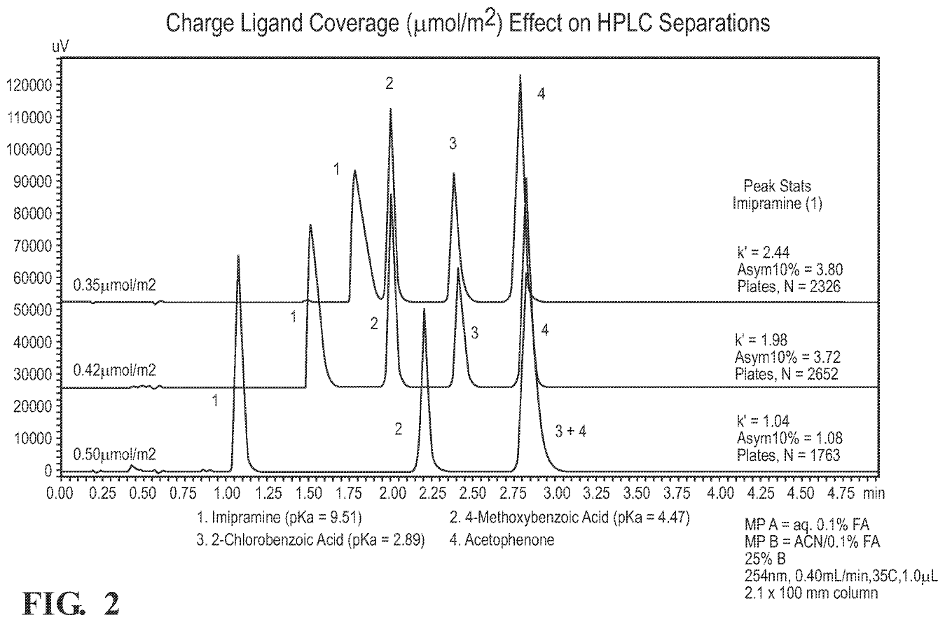

FIG. 2 shows the separation of various charged and uncharged compounds using HPLC columns loaded with materials produced with varying amounts of the PyrAmPrDiP ligand on the surface, wherein all of the materials were reacted with C18 hydrophobic ligand and TMS end-capping reagent. The separations were conducted in 0.1% formic acid mobile phase, wherein the pH in aqueous solution is about 3.5, and the PyrAmPrDiP ligand on the surface will be positively charged. At the lower density of 0.35 μmol/m², the basic analyte, imipramine, exhibits comparably higher retention and poor peak shape, with a tailing factor of 3.80. Increasing charged ligand density progressively improved the basic compound peak shape, at 0.42 and 0.5 μmol/m², exhibiting tailing of 3.72 and 1.08, respectively, with corresponding decrease in retention times. The less acidic compound, 4-Methoxybenzoic acid (pKa=4.47), is expected to be mostly uncharged, with a mild anionic character, shows modest increase with increasing density of the positive surface ligand. The comparably acidic compound, 2-chlorobenzoic acid (pKa=2.89), is expected to be negatively charged under these conditions, and shows higher retention as the density increases, co-eluting with acetophenone at 0.5 μmol/m². The neutral compound, acetophenone, exhibited little dependence of retention or peak shape on the level of the charged ligand on the surface. For any given mixture of acidic, basic and neutral compounds, charge density on the surface, and quantity of corresponding hydrophobic ligand will determine the exact retention position. Peak shape for basic compounds is highly dependent on the amount of charged ligand present on the surface of the mixed charged and hydrophobic particle surface.

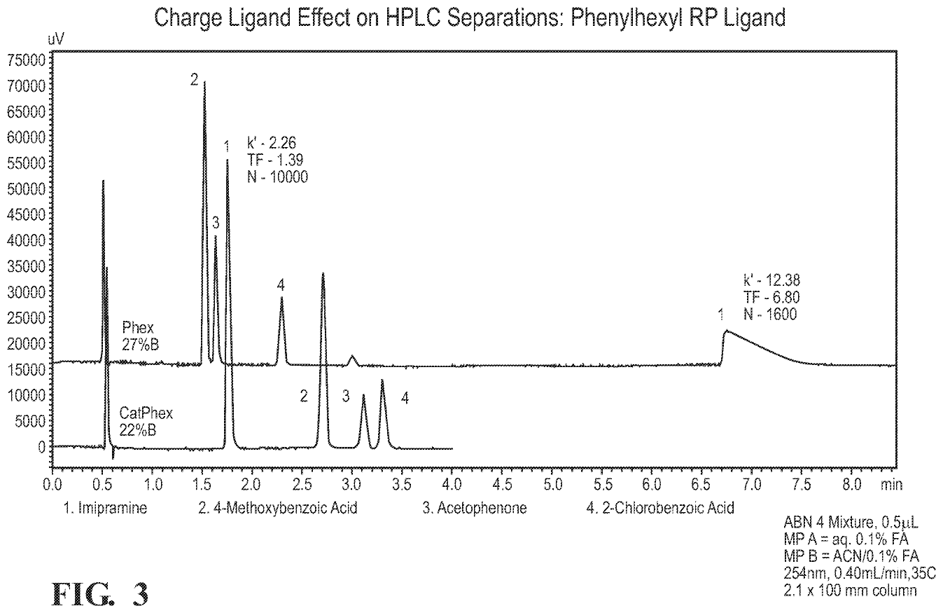

FIG. 3 shows an example of a modified (PyrAmPrDiP) surface that was reacted with the phenylhexyl silane as the hydrophobic modifier (i.e., second ligand), then subjected to characterization by HPLC separations of a mixture of small organic molecules (CatPhex). For comparison, a surface that was not modified with the charged silane, modified with the phenylhexyl ligand as the surface modifier, is employed for a similar separation (Phex). It is notable that the strongly basic compound, imipramine, is more strongly retained, with poor peak shape, on the Phex material, compared to the Cat Phex modified silica particle column packing material. In this example, the benefit of using the charged ligand to improve the peak shape is independent of the properties of the hydrophobic ligand employed to encourage retention in reversed-phase HPLC separations.

It is to be understood that the appended claims are not limited to express any particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present disclosure independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present disclosure has been described in an illustrative manner, and it is to be understood that the terminology which has been used is intended to be in the nature of words of description rather than of limitation. Many modifications and variations of the present disclosure are possible in light of the above teachings. The present disclosure may be practiced otherwise than as specifically described. The subject matter of all combinations of independent and dependent claims, both singly and multiply dependent, is herein expressly contemplated.

1. A chromatographic composition comprising:
a solid phase substrate; and
a first ligand covalently bonded to the solid phase substrate and represented by Formula I: 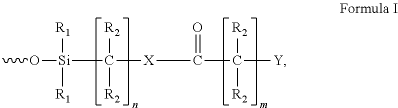
wherein
R₁ is independently selected from H or a straight or branched, substituted or unsubstituted, C1 to C18 alkyl group,
R₂ is independently selected from H or a straight or branched, substituted or unsubstituted, C1 to C18 alkyl group;
n is 2 to 8;
m is 0 to 4
X is O or N, and
Y is a substituted or unsubstituted cyclic ring(s) structure including at least one nitrogen atom.

2. The chromatographic composition of claim 1 wherein R₂ is hydrogen and m is 0.

3. The chromatographic composition of claim 1 wherein X is nitrogen.

4. The chromatographic composition of claim 1 wherein Y is derived from pyridine or pyrrole.

5. The chromatographic composition of claim 1 wherein R₁ is a straight or branched, unsubstituted, C1 to C6 alkyl group.

6. The chromatographic composition of claim 1 wherein the first ligand covalently bonded to the solid phase substate is represented by Formula Ia:

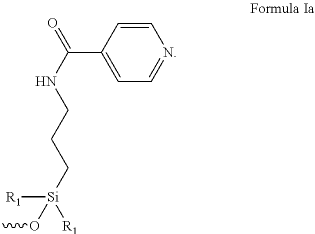

7. The chromatographic composition of claim 1 further comprising a second ligand covalently bonded to the solid phase substrate and represented by Formula II: 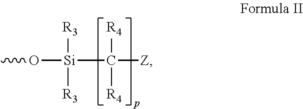
wherein
R₃ is independently selected from H or a straight or branched, substituted or unsubstituted, C1 to C18 alkyl group,
R₄ is independently selected from H or a straight or branched C1 to C17 alkyl group;
Z is a methyl or a phenyl group, with the phenyl group being optionally substituted with at least one halogen; and
p is 2 to 29.

8. The chromatographic composition of claim 7 wherein R₃ is a straight or branched, C1 to C6 alkyl group, R₄ is hydrogen, p is 17, and Z is methyl.

9. The chromatographic composition of claim 7 wherein R₃ is a straight or branched, C1 to C6 alkyl group, R₄ is hydrogen, p is 6, and Z is a phenyl group.

10. The chromatographic composition of claim 1 further comprising an end capped product covalently coupled to the solid phase substrate represented by Formula III: 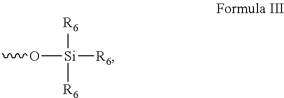
wherein R₆ is independently selected from a hydrophobic structure including at least one carbon atom, which may be a substituted or unsubstituted aliphatic, cyclic, acyclic, aromatic hydrocarbon, heterocyclic compound, or combination thereof.

11. The chromatographic composition of claim 10 wherein each R₆ is a methyl group.

12. The chromatographic composition of claim 1 wherein the first ligand covalently bonded to the solid phase substrate is represented by Formula Ia 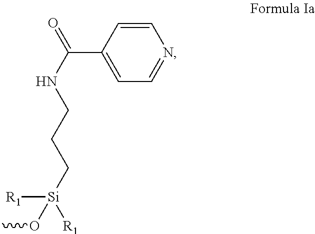
wherein the chromatographic composition further comprises a second ligand covalently bonded to the solid phase substrate represented by Formula II, and an end capped product covalently bonded to the solid phase substrate represented by Formula III: 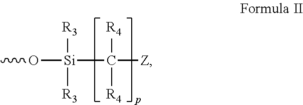
wherein
R₃ is independently selected from H or a straight or branched, substituted or unsubstituted, C1 to C18 alkyl group,
R₄ is independently selected from H or a straight or branched C1 to C17 alkyl group, and
p is 2 to 29; 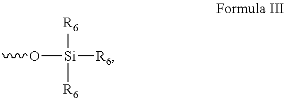
wherein R₆ is independently selected from a hydrophobic structure including at least one carbon atom, which may be a substituted or unsubstituted aliphatic, cyclic, acyclic, aromatic hydrocarbon, heterocyclic compound, or combination thereof.

13. The chromatographic composition of claim 12 wherein the first ligand, second ligand, and end capped product are present in a molar ratio range of from 5 to 90 mol % of the first ligand, 5 to 90 mol. % of the second ligand, and 1 to 80 mol. % of the end capped product.

14. The chromatographic composition of claim 1 wherein the solid phase substrate is a silica material or a hybrid inorganic/organic material.

15. (canceled)

16. (canceled)

17. (canceled)

18. (canceled)

19. A method of producing a chromatographic composition, the method comprising:
providing a solid phase substrate,
providing a first ligand portion represented by Formula IV 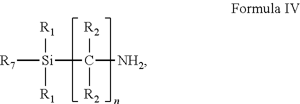
wherein R₁ is independently selected from H or a straight or branched, substituted or unsubstituted, C1 to C18 alkyl group,
R₂ is independently selected from H or a straight or branched, substituted or unsubstituted, C1 to C18 alkyl group,
R₇ is a leaving group; and
n is 2 to 8;
reacting the solid phase substrate and the first ligand portion to covalently couple the solid phase substrate and the first ligand portion and form a first intermediate;
providing an amide-forming reaction compound represented by Formula V: 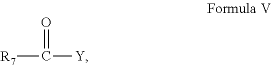
wherein R7 is a leaving group and Y is the substituted or unsubstituted cyclic ring(s) structure including at least one nitrogen atom, and
reacting the amide-forming reaction compound and the first intermediate to produce a first ligand covalently coupled to the solid phase substrate and thereby produce the chromatographic composition.

20. The method as set forth in claim 19 wherein the amide-forming reaction compound is isonicotinoyl chloride or ethyl isonicotinate.

21. The method as set forth in claim 19 wherein the wherein the first ligand covalently bonding to the solid phase substrate is represented by Formula Ia:

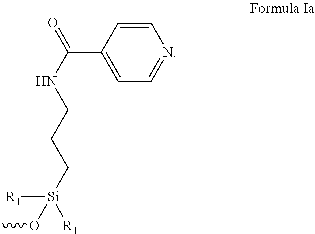

22. The method as set forth in claim 19 further comprising providing a second ligand portion represented by Formula VI and reacting the second ligand portion with the solid phase substrate to form a second ligand: 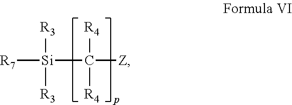
wherein R₃ is independently selected from H or a straight or branched, substituted or unsubstituted, C1 to C18 alkyl group,
R₄ is independently selected from H or a straight or branched C1 to C17 alkyl group;
R₇ is a leaving group,
Z is a methyl or a phenyl group, with the phenyl group being optionally substituted with at least one halogen; and
p is 2 to 29.

23. (canceled)

24. (canceled)

25. The method of claim 22 further comprising providing an end capping reagent represented by Formula VII and reacting the end capping reagent with the solid phase substrate: 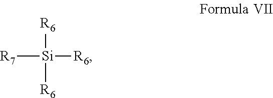
wherein R₆ is independently selected from a hydrophobic structure including at least one carbon atom, which may be a substituted or unsubstituted aliphatic, cyclic, acyclic, aromatic hydrocarbon, heterocyclic compound, or combination thereof, and R₇ is a leaving group.

26. (canceled)

27. (canceled)

28. A method of producing a chromatographic composition, the method comprising:
providing a first ligand portion represented by Formula IV: 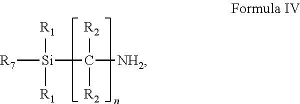
wherein R₁ is independently selected from H or a straight or branched, substituted or unsubstituted, C1 to C18 alkyl group,
R₂ is independently selected from H or a straight or branched, substituted or unsubstituted, C1 to C18 alkyl group,
R₇ is a leaving group; and
n is 2 to 8;
providing an amide-forming reaction compound represented by Formula V: 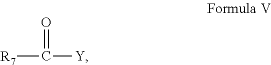
wherein R7 is a leaving group and Y is the substituted or unsubstituted cyclic ring(s) structure including at least one nitrogen atom;
reacting the first ligand portion and the amide-forming reaction compound to produce an off-particle reaction product;
providing a solid phase substrate; and
reacting the solid phase substrate and the off-particle reaction product to covalently couple the solid phase substrate and the off-particle reaction product and thereby produce the chromatographic composition.

29. (canceled)

30. The method as set forth in claim 28 wherein the wherein the off-particle reaction product for covalently bonding to the solid phase substrate is represented by Formula Ib

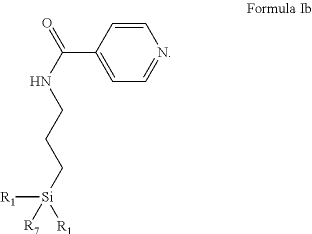

31. The method as set forth in claim 28 further comprising providing a second ligand portion represented by Formula VI and reacting the second ligand portion with the solid phase substrate to form a second ligand covalently bonded to the solid phase substrate 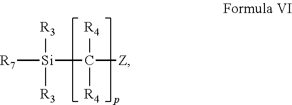
wherein R₃ is independently selected from H or a straight or branched, substituted or unsubstituted, C1 to C18 alkyl group,
R₄ is independently selected from H or a straight or branched C1 to C17 alkyl group;
R₇ is a leaving group,
Z is a methyl or a phenyl group, with the phenyl group being optionally substituted with at least one halogen, and
p is 2 to 29.

32. (canceled)

33. (canceled)

34. The method of claim 31 further comprising:
providing an end capping reagent represented by Formula VII: 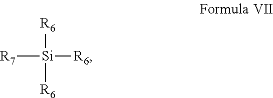
wherein R₆ is independently selected from a hydrophobic structure including at least one carbon atom, which may be a substituted or unsubstituted aliphatic, cyclic, acyclic, aromatic hydrocarbon, heterocyclic compound, or combination thereof, and R₇ is a leaving group; and
and reacting the end capping reagent with the solid phase substrate to form an end capped product.

35. (canceled)

36. (canceled)

37. The chromatographic composition of claim 1 wherein R₂ is hydrogen and m is 0, and X is nitrogen.

38. The chromatographic composition of claim 37 wherein Y is derived from pyridine or pyrrole, and R₁ is a straight or branched, unsubstituted, C1 to C6 alkyl group.
